(19) United States
(12) Patent Application Publication
(10) Pub. No.: US 2013/0141520 A1
(43) Pub. Date: Jun. 6, 2013

(54) LANE TRACKING SYSTEM

(71) Applicants: Wende Zhang, Troy, MI (US); Bakhtiar Brian Litkouhi, Washington, MI (US)

(72) Inventors: Wende Zhang, Troy, MI (US); Bakhtiar Brian Litkouhi, Washington, MI (US)

(73) Assignee: GM GLOBAL TECHNOLOGY OPERATIONS LLC, Detroit, MI (US)

(21) Appl. No.: 13/589,214

(22) Filed: Aug. 20, 2012

Related U.S. Application Data
(60) Provisional application No. 61/566,042, filed on Dec. 2, 2011.

(51) Int. Cl. H04N 7/18

(52) U.S. Cl. 348/36; 348/149; 348/E07.085

(57) ABSTRACT

A lane tracking system for a motor vehicle includes a camera and a lane tracking processor. The camera is configured to receive image of a road from a wide-angle field of view and generate a corresponding digital representation of the image. The lane tracking processor is configured to receive the digital representation of the image from the camera and to: detect one or more lane boundaries, each lane boundary including a plurality of lane boundary points; convert the plurality of lane boundary points into a Cartesian vehicle coordinate system; and fit a reliability-weighted model lane line to the plurality of points.

### CROSS REFERENCE TO RELATED APPLICATIONS

This application claims the benefit of U.S. Provisional Application No. 61/566,042, filed Dec. 2, 2011, which is hereby incorporated by reference in its entirety.

### TECHNICAL FIELD

The present invention relates generally to systems for enhancing the lane tracking ability of an automobile.

### BACKGROUND

Vehicle lane tracking systems may employ visual object recognition to identify bounding lane lines marked on a road. Through these systems, visual processing techniques may estimate a position between the vehicle and the respective lane lines, as well as a heading of the vehicle relative to the lane.

Existing automotive vision systems may utilize forward-facing cameras that may be aimed substantially at the horizon to increase the potential field of view. When a leading vehicle comes too close to the subject vehicle, however, the leading vehicle may obscure the camera's view of any lane markers, thus making recognition of bounding lane lines difficult or impossible.

### SUMMARY

A lane tracking system for a motor vehicle includes a camera and a lane tracking processor. The camera is configured to receive image of a road from a wide-angle field of view and generate a corresponding digital representation of the image. In one configuration, the camera may be disposed at a rear portion of the vehicle, and may include a field of view greater than 130 degrees. Additionally, the camera may be pitched downward by an amount greater than 25 degrees from the horizontal.

The lane tracking processor is configured to receive the digital representation of the image from the camera and to: detect one or more lane boundaries, with each lane boundary including a plurality of lane boundary points; convert the plurality of lane boundary points into a Cartesian vehicle coordinate system; and fit a reliability-weighted model lane line to the plurality of points.

When constructing the reliability-weighted model lane line, the lane tracking processor may assign a respective reliability weighting factor to each lane boundary point, and then construct the reliability-weighted model lane line to account for the assigned reliability weighting factors. As such the reliability-weighted model lane line may give a greater weighting/influence to a point with a larger weighting factor than a point with a smaller weighting factor. The reliability weighting factors may largely be dependent on where the point is acquired within the image frame. For example, in one configuration, the lane tracking processor may be configured to assign a larger reliability weighting factor to a lane boundary point identified in a central region of the image than a point identified proximate an edge of the image. Similarly, the lane tracking processor is configured to assign a larger reliability weighting factor to a lane boundary point identified proximate the bottom (foreground) of the image than a point identified proximate the center (background) of the image.

The lane tracking processor may further be configured to determine a distance between the vehicle and the model lane line, and perform a control action if the distance is below a threshold.

When detecting the lane boundaries from the image, the lane tracking processor may be configured to: identify a horizon within the image; identify a plurality of rays within the image; and detect one or more lane boundaries from the plurality of rays within the image, wherein the detected lane boundaries converge to a vanishing region proximate the horizon. Moreover, the lane tracking processor may further be configured to reject a ray of the plurality of rays if the ray crosses the horizon.

In a similar manner, a lane tracking method includes: acquiring an image from a camera disposed on a vehicle, the camera having a field of view configured to include a portion of a road; identifying a lane boundary within the image, the lane boundary including a plurality of lane boundary points; converting the plurality of lane boundary points into a Cartesian vehicle coordinate system; and fitting a reliability-weighted model lane line to the plurality of points.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic top view diagram of a vehicle including a lane tracking system.

FIG. 2 is a schematic top view diagram of a vehicle disposed within a lane of a road.

FIG. 3 is a flow diagram of a method of computing reliability-weighted model lane lines from continuously acquired image data.

FIG. 4 is a schematic illustration of an image frame that may be acquired by a wide-angle camera disposed on a vehicle.

FIG. 5 is a flow diagram of a method for identifying bounding lane lines within an image.

FIG. 6 is the image frame of FIG. 4, augmented with bounding lane line information.

FIG. 7 is a schematic top view of a vehicle coordinate system including a plurality of reliability-weighted model lane lines.

FIG. 8 is a schematic image frame including a scale for adjusting the reliability weighting of perceived lane information according to its distance from the bottom edge.

FIG. 9 is a schematic image frame including bounding area for adjusting the reliability weighting of perceived lane information, according to an estimated amount of fish-eye distortion.

### DETAILED DESCRIPTION

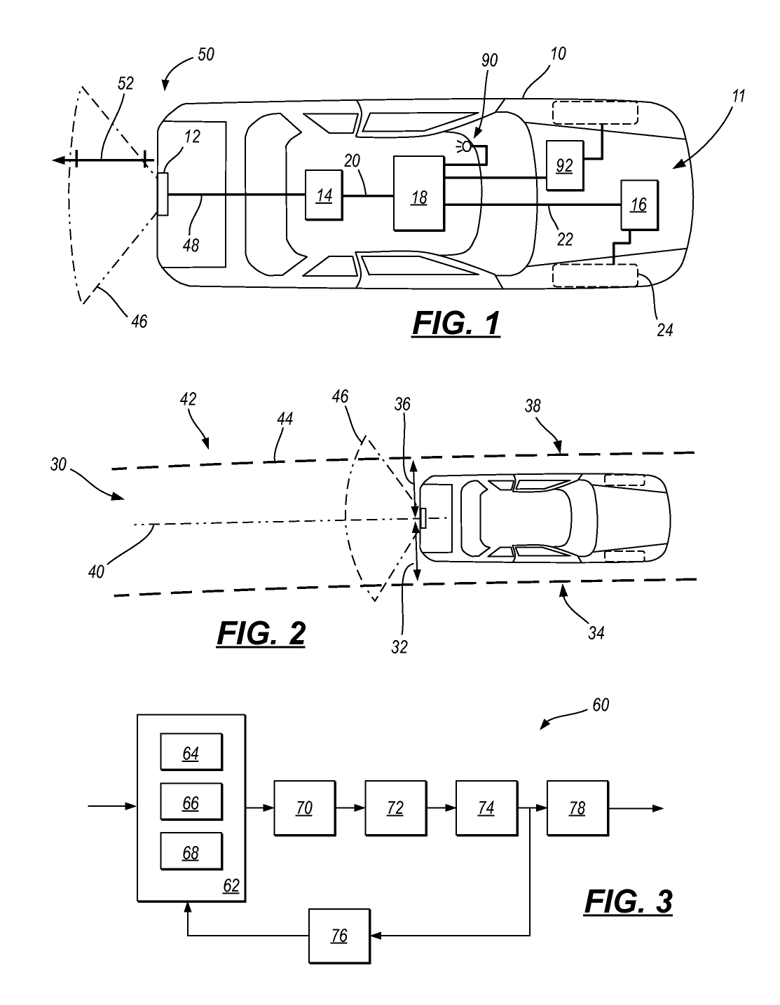

Referring to the drawings, wherein like reference numerals are used to identify like or identical components in the various views, FIG. 1 schematically illustrates a vehicle 10 with a lane tracking system 11 that includes a camera 12, a video processor 14, a vehicle motion sensor 16, and a lane tracking processor 18. As will be described in greater detail below, the lane tracking processor 18 may analyze and/or assess acquired and/or enhanced image data 20, together with sensed vehicle motion data 22 to determine the position of the vehicle 10 within a traffic lane 30 (as generally illustrated in FIG. 2). In one configuration, the lane tracking processor 18 may determine in near-real time, the distance 32 between the vehicle 10 and a right lane line 34, the distance 36 between the vehicle 10 and a left lane line 38, and/or the heading 40 of the vehicle 10 relative to the lane 30.

The video processor 14 and lane tracking processor 18 may each be respectively embodied as one or multiple digital computers or data processing devices, each having one or more microprocessors or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, input/output (I/O) circuitry, power electronics/transformers, and/or signal conditioning and buffering electronics. The individual control/processing routines resident in the processors 14, 18 or readily accessible thereby may be stored in ROM or other suitable tangible memory locations and/or memory devices, and may be automatically executed by associated hardware components of the processors 14, 18 to provide the respective processing functionality. In another configuration, the video processor 14 and lane tracking processor 18 may be embodied by a single device, such as a digital computer or data processing device.

As the vehicle 10 travels along the road 42, one or more cameras 12 may visually detect lane markers 44 that may be painted or embedded on the surface of the road 42 to define the lane 30. The one or more cameras 12 may each respectively include one or more lenses and/or filters adapted to receive and/or shape light from within the field of view 46 onto an image sensor. The image sensor may include, for example, one or more charge-coupled devices (CCDs) configured to convert light energy into a digital signal. The camera 12 may output a video feed 48, which may comprise, for example, a plurality of still image frames that are sequentially captured at a fixed rate (i.e., frame rate). In one configuration, the frame rate of the video feed 48 may be greater than 5 Hertz (Hz), however in a more preferable configuration, the frame rate of the video feed 48 may be greater than 10 Hertz (Hz).

The one or more cameras 12 may be positioned in any suitable orientation/alignment with the vehicle 10, provided that they may reasonably view the one or more objects or markers 44 disposed on or along the road 42. In one configuration, as generally shown in FIGS. 1 and 2, the camera 12 may be disposed on the rear portion 50 of the vehicle 10, such that it may suitably view the road 42 immediately behind the vehicle 10. In this manner, the camera 12 may also provide rearview back-up assist to a driver of the vehicle 10. To maximize the visible area behind the vehicle 10, such as when also serving a back-up assist function, the camera 12 may include a wide-angle lens to enable a field of view 46 greater than, for example, 130 degrees. Additionally, to further maximize the visible area immediately proximate to the vehicle 10, the camera 12 may be pitched downward toward the road 42 by an amount greater than, for example, 25 degrees from the horrizontal. In this manner, the camera 12 may perceive the road 42 within a range 52 of 0.1 m-20 m away from the vehicle 10, with the best resolution occurring in the range of, for example, 0.1 m-1.5 m. In another configuration, the camera 12 may be similarly configured with a wide field of view 46 and downward pitch, though may be disposed on the front grille of the vehicle 10 and generally oriented in a forward facing direction.

The video processor 14 may be configured to interface with the camera 12 to facilitate the acquisition of image information from the field of view 46. For example, as illustrated in the method of lane tracking 60 provided in FIG. 3, the video processor 14 may begin the method 60 by acquiring an image 62 that may be suitable for lane detection. More particularly, acquiring an image 62 may include directing the camera 12 to capture an image 64, dynamically adjusting the operation of the camera 12 to account for varying lighting conditions 66, and/or correcting the acquired image to reduce any fish-eye distortion 68 that may be attributable to the wide-angle field of view 46.

In one configuration, the lighting adjustment feature 66 may use visual adjustment techniques known in the art to capture an image of the road 42 with as much visual clarity as possible. Lighting adjustment 66 may, for example, use lighting normalization techniques such as histogram equalization to increase the clarity of the road 42 in low light conditions (e.g., in a scenario where the road 42 is illuminated only by the light of the vehicle's tail lights). Alternatively, when bright, spot-focused lights are present (e.g., when the sun or trailing head-lamps are present in the field of view 46), the lighting adjustment 66 may allow the localized bright spots to saturate in the image if the spot brightness is above a pre-determined threshold brightness. In this manner, the clarity of the road will not be compromised in an attempt to normalize the brightness of the frame to include the spot brightness.

The fish-eye correction feature 68 may use post-processing techniques to normalize any visual skew of the image that may be attributable to the wide-angle field of view 46. It should be noted that while these adjustment techniques may be effective in reducing any fish-eye distortion in a central portion of the image, they may be less effective toward the edges of the frame where the skew is more severe.

Following the image acquisition 62, the video processor 14 may provide the acquired/corrected image data 20 to the lane tracking processor 18 for further computation and analysis. As provided in the method 60 of FIG. 3 and discussed below, the lane tracking processor 18 may then identify one or more lane boundaries (e.g., boundaries 34, 38) within the image (step 70); perform camera calibration to normalize the lane boundary information and convert the lane boundary information into a vehicle coordinate system (step 72); construct reliability-weighted, model lane lines according to the acquired/determined lane boundary information (step 74); and finally, the processor 18 may compensate/shift any acquired/determined lane boundary information based on sensed motion of the vehicle (step 76) before repeating the image acquisition 62 and subsequent analysis. Additionally, depending on the vehicle position relative to the model lane lines, the lane tracking processor 18 may execute a control action (step 78) to provide an alert 90 to a driver of the vehicle and/or take corrective action via a steering module 92 (as shown schematically in FIG. 1).

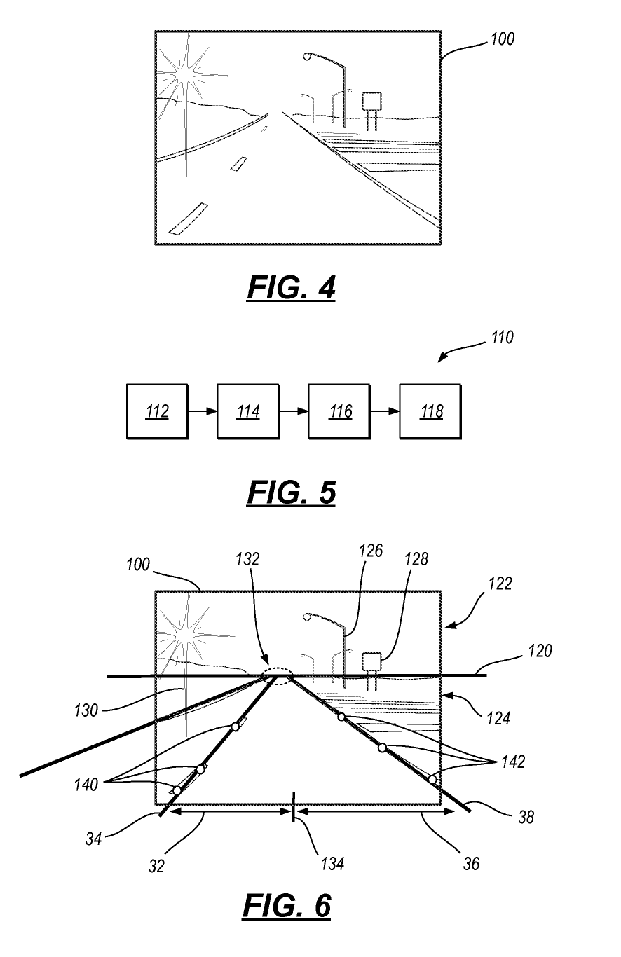

FIG. 4 represents an image frame 100 that may be received by the lane tracking processor 18 following the image acquisition at step 62. In one configuration, the lane tracking processor 18 may identify one or more lane boundaries (step 70) using a method 110 such as illustrated in FIG. 5 (and graphically represented by the augmented image frame 100 provided in FIG. 6). As shown, the processor 18 may begin by identifying a horizon 120 within the image frame 100 (step 112). The horizon 120 may be generally horizontal in nature, and may separate a sky region 122 from a land region 124, which may each have differing brightnesses or contrasts.

Once the horizon 120 is detected, the processor 18 may examine the frame 100 to detect any piecewise linear lines or rays that may exist (step 114). Any such line/rays that extend across the horizon 120 may be rejected as not being a lane line in step 116. For example, as shown in FIG. 6, street lamps 126, street signs 128, and/or blooming effects 130 of the sun may be rejected at this step. Following this initial artifact rejection, the processor 18 may detect one or more lines/rays that converge from the foreground to a common vanishing point or vanishing region 132 near the horizon 120 (step 118). The closest of these converging lines to a center point 134 of the frame may then be regarded as the lane boundaries 34, 38.

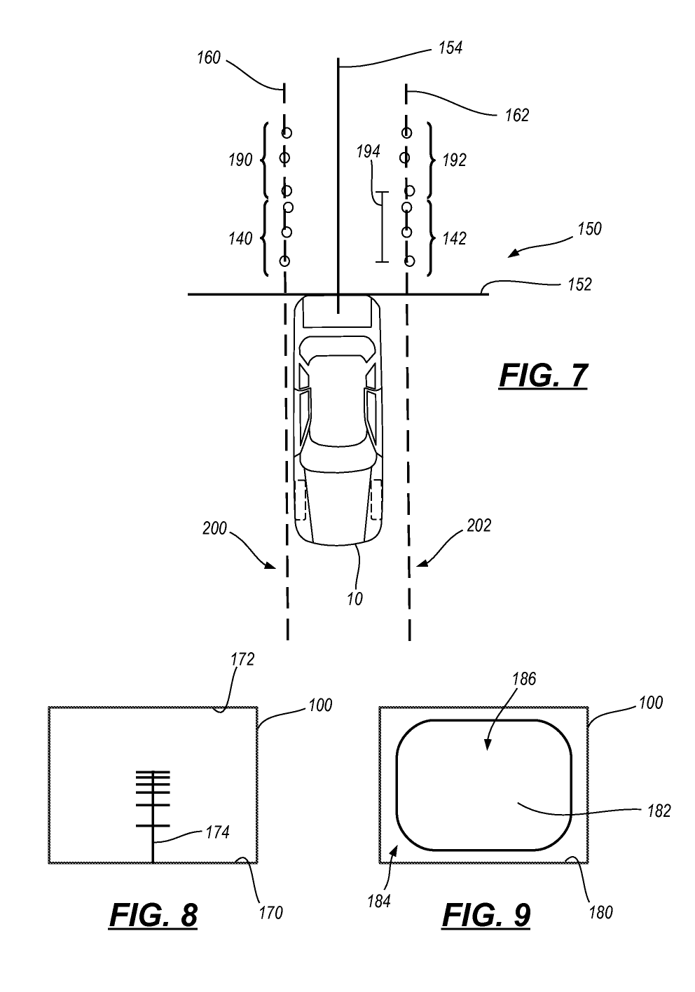

As further illustrated in FIG. 6, each of the lane boundaries 34, 38 may be defined by a respective plurality of points. For example, lane boundary 34 may be defined by a first plurality of points 140, and lane boundary 38 may be defined by a second plurality of points 142. Each point may represent a detected road marker, hash 44, or other visual transition point within the image that may potentially represent the lane boundary or edge of the road surface. Referring again to the method 60 illustrated in FIG. 3, in step 72, the plurality of boundary points 140, 142 defining the detected boundary lines 34, 38 (i.e., lane boundary information) may then be converted into a vehicle coordinate system 150, such as illustrated in FIG. 7. As shown, each point from the perspective image frame 100 (FIG. 6) may be represented on a Cartesian coordinate system 150 having a cross-car dimension 152 and a longitudinal dimension 154.

In step 74 of FIG. 3, the processor 18 may construct a reliability-weighted, model lane line 160, 162 for each of the respective plurality of (Cartesian) points 140, 142 that were acquired/determined from the image frame 100. To construct the modeled lane lines 160, 162, each point of the respective plurality of points 140, 142 may be assigned a respective weighting factor that may correspond to one or more of a plurality of reliability factors. These reliability factors may indicate a degree of confidence that the system may have with respect to each particular point, and may include measures of, for example, hardware margins of error and variability, ambient visibility, ambient lighting conditions, and/or resolution of the image. Once a weighting factor has been assigned to each point, a model lane line may be fit to the points according to the weighted position of the points.

FIGS. 8 and 9 generally illustrate two reliability assessments that may influence the weighting factor for a particular point. As shown in FIG. 8, due to the strong perspective view of the pitched, fish-eye camera, objects shown in the immediate foreground of the image frame 100 may be provided with a greater resolution than objects toward the horizon. In this manner, a position determination may be more robust and/or have a lower margin of error if recorded near the bottom 170 of the frame 100 (i.e., the foreground). Therefore, a point recorded closer to the bottom 170 of the frame 100 may be assigned a larger reliability weight than a point recorded closer to the top 172. In one embodiment, the weights may be reduced as an exponential of the distance from the bottom 170 of the frame (e.g. along the exponential scale 174).

As shown in FIG. 9, due to the fish-eye distortion, points perceived immediately adjacent the edge 180 of the frame 100 may be more severely distorted and/or skewed than points in the middle 182 of the frame. This may be true, even despite attempts at fish-eye correction 68 by the video processor 14. Therefore, a point recorded in a band 184 near the edge may be assigned a lower reliability weight than a point recorded in a more central region 186. In another embodiment, this weighting factor may be assigned according to a more gradual scale that may radiate outward from the center of the frame 100.

In still further examples, the ambient lighting and/or visibility may influence the reliability weighting of the recorded points, and/or may serve to adjust the weighting of other reliability analyses. For example, in a low-light environment, or in an environment with low visibility, the scale 174 used to weight points as a function of distance from the bottom 170 of the image frame 100 may be steepened to further discount perceived points in the distance. This modification of the scale 174 may compensate for low-light noise and/or poor visibility that may make an accurate position determination more difficult at a distance.

Once the point-weights are established, the processor 18 may use varying techniques to generate a weighted best-fit model lane line (e.g., reliability-weighted, model lane lines 160, 162). For example, the processor 18 may use a simple weighted average best fit, a rolling best fit that gives weight to a model lane line computed at a previous time, or may employ Kalman filtering techniques to integrate newly acquired point data into older acquired point data. Alternatively, other modeling techniques known in the art may similarly be used.

Once the reliability-weighted lane lines 160, 162 have been established, the processor 18 may then compensate and/or shift the lane points in a longitudinal direction 154 to account for any sensed forward motion of the vehicle (step 76) before repeating the image acquisition 62 and subsequent analysis. The processor 18 may perform this shift using vehicle motion data 22 obtained from the vehicle motion sensors 16. In one configuration, this motion data 22 may include the angular position and/or speed of one or more vehicle wheels 24, along with the corresponding heading/steering angle of the wheel 24. In another embodiment, the motion data 22 may include the lateral and/or longitudinal acceleration of the vehicle 10, along with the measured yaw rate of the vehicle 10. Using this motion data 22, the processor may cascade the previously monitored lane boundary points longitudinally away from the vehicle as newly acquired points are introduced. For example, as generally illustrated in FIG. 7, points 140, 142 may have been acquired during a current iteration of method 60, while points 190, 192 may have been acquired during a previous iteration of the method 60 (i.e., where the vehicle has generally moved forward a distance 194).

When computing the reliability weights for each respective point, the processor 18 may further account for the reliability of the motion data 22 prior to fitting the model lane lines 160, 162. Said another way, the vehicle motion and/or employed dead reckoning computations may be limited by certain assumptions and/or limitations of the sensors 16. Over time, drift or errors may compound, which may result in compiled path information being gradually more inaccurate. Therefore, while a high reliability weight may be given to more recently acquired points, this weighting may decrease as a function of elapsed time and/or vehicle traversed distance.

In addition to the reliability-weighted lane lines 160, 162 being best fit through the plurality of points behind the vehicle, the model lane lines 160, 162 may also be extrapolated forward (generally at 200, 202) for the purpose of vehicle positioning and/or control. This extrapolation may be performed under the assumption that roadways typically have a maximum curvature. Therefore, the extrapolation may be statistically valid within a predetermined distance in front of the vehicle 10. In another configuration, the extrapolation forward may be enhanced, or further informed using real-time GPS coordinate data, together with map data that may be available from a real-time navigation system. In this manner, the processor 18 may fuse the raw extrapolation together with an expected road curvature that may be derived from the vehicle's sensed position within a road-map. This fusion may be accomplished, for example, through the use of Kalman filtering techniques, or other known sensor fusion algorithms.

Once the reliability-weighted lane lines 160, 162 are established and extrapolated forward, the lane tracking processor 18 may assess the position of the vehicle 10 within the lane 30 (i.e., distances 32, 36), and may execute a control action (step 78) if the vehicle is too close (unintentionally) to a particular line. For example, the processor 18 may provide an alert 90, such as a lane departure warning to a driver of the vehicle. Alternatively (or in addition), the processor 18 may initiate corrective action to center the vehicle 10 within the lane 30 by automatically controlling a steering module 92.

Due to the temporal cascading of the present lane tracking system, along with the dynamic weighting of the acquired lane position points, the modeled, reliability-weighted lane lines 160, 162 may be statistically accurate at both low and high speeds. Furthermore, the dynamic weighting may allow the system to account for limitations of the various hardware components and/or ambient conditions when determining the position of the lane lines from the acquired image data.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A lane tracking system for a motor vehicle, the system comprising:
a camera configured to receive image from a wide-angle field of view and generate a corresponding digital representation of the image;
a lane tracking processor configured to receive the digital representation of the image and further configured to:
detect one or more lane boundaries, each lane boundary including a plurality of lane boundary points;
convert the plurality of lane boundary points into a Cartesian vehicle coordinate system; and
fit a reliability-weighted model lane line to the plurality of points.

2. The system of claim 1, wherein the lane tracking processor is further configured to:
assign a respective reliability weighting factor to each lane boundary point of the plurality of lane boundary points;
fit a reliability-weighted model lane line to the plurality of points; and
wherein the reliability-weighted model lane line gives a greater weighting to a point with a larger weighting factor than a point with a smaller weighting factor.

3. The system of claim 2, wherein the lane tracking processor is configured to assign a larger reliability weighting factor to a lane boundary point identified in a central region of the image than a point identified proximate an edge of the image.

4. The system of claim 2, wherein the lane tracking processor is configured to assign a larger reliability weighting factor to a lane boundary point identified in the foreground of the image than a point identified in the background of the image.

5. The system of claim 1, wherein the lane tracking processor is further configured to:
determine a distance between the vehicle and the model lane line; and
perform a control action if the distance is below a threshold.

6. The system of claim 1, wherein the camera is disposed at a rear portion of the vehicle; and
wherein the camera has a field of view greater than 130 degrees.

7. The system of claim 6, wherein the camera is pitched downward by an amount greater than 25 degrees from the horizontal.

8. The system of claim 1, wherein the lane tracking processor is further configured to:
identify a horizon within the image;
identify a plurality of rays within the image; and
detect one or more lane boundaries from the plurality of rays within the image, wherein the one or more lane boundaries converge to a vanishing region proximate the horizon.

9. The system of claim 8, wherein the lane tracking processor is further configured to reject a ray of the plurality of rays if the ray crosses the horizon.

10. The system of claim 1, further comprising a video processor configured to adjust a brightness of the image.

11. The system of claim 10, wherein the video processor is further configured to correct a fish-eye distortion of the image.

12. The system of claim 10, wherein adjusting a brightness of the image includes identifying a bright spot within the image, allowing the brightness of bright spot to saturate, and normalizing the brightness of the portion of the image that excludes the bright spot.

13. A lane tracking method comprising:
acquiring an image from a camera disposed on a vehicle, the camera having a field of view configured to include a portion of a road;
identifying a lane boundary within the image, the lane boundary including a plurality of lane boundary points;
converting the plurality of lane boundary points into a Cartesian vehicle coordinate system; and
fitting a reliability-weighted model lane line to the plurality of points.

14. The method of claim 13, wherein acquiring an image from a camera includes:
directing the camera to capture an image;
adjusting the operation of the camera to account for varying lighting conditions; and
correcting the acquired image to reduce any fish-eye distortion.

15. The method of claim 13 further comprising shifting the plurality of lane boundary points away from the vehicle according to vehicle motion data obtained from a vehicle motion sensor.

16. The method of claim 13 further comprising determining a distance between the vehicle and the model lane line, and performing a control action if the distance is below a threshold.

17. The method of claim 13, wherein fitting a reliability-weighted model lane line to the plurality of points includes:
assigning a respective reliability weighting factor to each lane boundary point of the plurality of lane boundary points;
fitting a reliability-weighted model lane line to the plurality of points; and
wherein the reliability-weighted model lane line gives a greater weighting to a point with a larger weighting factor than a point with a smaller weighting factor.

18. The method of claim 17, wherein assigning a respective reliability weighting factor to each lane boundary point includes assigning a larger reliability weighting factor to a lane boundary point identified in a central region of the image than a point identified proximate an edge of the image.

19. The method of claim 17, wherein assigning a respective reliability weighting factor to each lane boundary point includes assigning a larger reliability weighting factor to a lane boundary point identified in the foreground of the image than a point identified in the background of the image.

20. The method of claim 13, wherein identifying a lane boundary within the image:
identifying a horizon within the image;
identifying a plurality of rays within the image;
identifying one or more lane boundaries from the plurality of rays within the image, and wherein the one or more lane boundaries converge to a vanishing region proximate the horizon.
